(19) United States
(12) Patent Application Publication
(10) Pub. No.: US 2003/0206775 A1
(43) Pub. Date: Nov. 6, 2003

(54) Polyurethane/geotextile composite liner for canals and ditches based on liquefied monomeric MDI-derivatives

(76) Inventors: Peter H. Markusch, Sannibel, FL (US); Ralf Guether, Pittsburgh, PA (US)

Correspondence Address: BAYER POLYMERS LLC, 100 BAYER ROAD, PITTSBURGH, PA, 15205, US

(21) Appl. No.: 10/138,539

(22) Filed: May 3, 2002

(51) Int. Cl. E02D 5/18; E02D 17/20

(52) U.S. Cl. 405/268; 405/270; 405/302.7

(57) ABSTRACT

An improved polyurethane/geotextile composite is prepared from a polyurethane forming composition in which a liquefied monomeric diphenylmethane diisocyanate (MDI) is used as the isocyanate component. Such composites may be used to line canals and/or ditches by applying the geotextile soaked with polyurethane forming composition to the surface to be lined before the polyurethane-forming reaction has been completed and allowing the polyurethane to cure in place. These composites are characterized by improved physical and mechanical properties and the ability to withstand dramatic changes in the temperature of the environment in which they are employed.

### TECHNICAL FIELD OF THE INVENTION

The present invention relates to an improved polyurethane/geotextile composite prepared from liquefied monomeric diphenylmethane diisocyanate (MDI) and derivatives thereof, a process for producing such composite and the ditches and canals lined with such composite.

### BACKGROUND OF THE INVENTION

In recent years, the management of natural resources has become important in many countries throughout the world. Efforts have been directed both toward the conservation of our resources and toward the elimination of pollution from our environment. Particular emphasis has been placed on waste, leakage and water loss.

Water losses in the distribution of water using unlined irrigation ditches are estimated to be at least 25% and, in some situations, more than 50% depending upon the porosity of the ditch surface and the distance the water is being moved. In most rural areas, ditches are formed by excavating the soil to the desired depth and width. The water moves through the ditch in contact with the exposed natural surface. This surface can be sand, clay, rocks, etc. and, more commonly, mixtures thereof. The porosity will depend upon the proportions of the different components present in the soil.

The loss of water in unlined irrigation ditches at one time was considered acceptable only because the supply of water exceeded demand. However, as civilization developed and world population increased, more water was required for both greater food production and for the marked increase in non-agriculture uses. In addition to greater domestic uses in sanitation, industry now employs large quantities of water in manufacturing and processing procedures.

This high level of consumption plus the very high cost of developing new water supplies has shifted attention to water conservation. Domestic appliances that use less water have been developed. Also, industry has installed recycling purification systems to reduce water consumption.

Although conservation efforts have reduced water consumption to a degree, water is still in relatively short supply, particularly in recent years due to severe droughts in the United States and other countries. Since the most cost effective conservation opportunities and readily accessible water supplies have already been developed, greater attention must be directed to improving the efficiency of water distribution systems.

Some improvements in water distribution have already been made. A limited number of ditches and canals have been lined with concrete and/or preformed concrete pipes. Concrete is durable and has a long life when properly used. However, concrete is expensive to place and finish and is damaged by unfavorable temperatures during curing. Also, concrete is subject to frost damage, cracking and heaving which results in leaks.

In view of the problems encountered with concrete linings, attempts to line canals and ditches with materials that are durable but more cost effective, easier to use and better able to withstand unfavorable temperatures than concrete have been made. Among the materials which have been evaluated are polyurethanes. Processes for forming polyurethane composite liners for canals and ditches and apparatuses to perform such a processes are disclosed, for example, in U.S. Pat. Nos. 4,872,784; 4,955,759; 4,955,760; 5,049,006; 5,062,740; 5,421,677; 5,607,998; and 5,639,331.

U.S. Pat. No. 5,639,331 (“the '331 patent”) discloses an apparatus for forming a continuous structure by pre-selecting a liquid reactive resin forming material, a particulate solid additive material and a porous blanket. The additive particles are continuously mixed with the liquid resin-forming material in an amount significantly greater than that of the liquid resin-forming material. Suitable liquid reactive, resin-forming materials disclosed in the '331 patent include thermosetting resins such as polyurethanes or polyesters. The apparatus disclosed in the '331 patent is used on-site in the fabrication of composite liners for irrigation canals.

The '331 patent does not, however, teach that any of the disclosed resins would be more advantageous than any of the other known resins when used to fabricate composite liners for irrigation canals.

U.S. Pat. No. 5,421,677 (“the '677 patent”) also discloses a process for forming a ditch liner from a mixture which includes one or more fillers in an amount of up to 60% by weight based upon the total weight of the mixture. The mixture is dispensed on a geotextile to form a liquid, filler-containing polyurethane soaked geotextile composite. The liquid polyurethane soaked geotextile composite is then placed over the surface of an area to be lined. The isocyanates taught to be preferred are commercially available phosgenation products of aniline/formaldehyde condensates, i.e., polymethylene poly(phenylisocyanates) which are liquid at room temperature and usually do not freeze even at temperatures as low as 5° C. However, these isocyanates have functionalities that range on average between 2.3 and 3.0. Consequently, when the isocyanate is reacted with a polyether polyol (as shown in the example of the '677 patent) polyurethanes having poor elastomer properties (elongation, tensile strength, tear strength) are obtained.

Applicants' co-pending application Ser. Nos. 09/809,023; 09/809,453; 09/808,812; 09/809,445; 09/809,604; and 09/809,671 (all of which have a filing date of Mar. 15, 2001) disclose improved polyurethane-forming compositions useful in the production of composites suitable for lining ditches and canals which include polymeric MDI as the isocyanate in which many of these problems are overcome by use of specific types of isocyanate-reactive materials.

Monomeric 4,4′-diphenylmethane diisocyanate (“MDI”) on the other hand is a solid at room temperature and has a melting point of about 39° C. It also reacts with itself to form MDI dimer at temperatures above its melting point. The dimer is an insoluble solid that shows up in the form of turbidity before precipitation occurs. Consequently, those skilled in the art would not consider monomeric MDI to be a viable candidate for use in outdoor applications subject to temperatures down to 0° C.

### SUMMARY OF THE INVENTION

It would be desirable to develop polyurethane formulations which include an isocyanate that is stable, has a low viscosity at temperatures between 20° C. and 0° C. and will produce polyurethane elastomers with physical properties equal or superior to those obtainable from polymethylene poly(phenylisocyanates) but which did not require several different types of isocyanate-reactive materials for use in lining ditches and canals.

This desirable result is achieved by the present invention in which monomeric and/or modified monomeric MDI types which are liquid at temperatures below 20° C., have a functionality of about two, a sufficiently low viscosity that they may be easily used, a low freezing point, and good stability towards dimer formation are employed.

The present invention is directed to an improved polyurethane/geotextile composite useful as a liner for canals and ditches, to a process for the production of such composites, to a process for lining canals and ditches with such composite material and to the lined canals and ditches made by this process. The composites of the present invention are made from a geotextile which has been substantially soaked with a polyurethane-forming composition which includes a liquefied monomeric diphenylmethane diisocyanate, an isocyanate-reactive compound, an organometallic catalyst, optionally, a viscosity-adjusting compound and optionally, fillers, additives and auxiliary agents. Upon curing, the polyurethane-soaked geotextile forms a polyurethane/geotextile composite material having particularly advantageous properties. Prior to complete curing of the polyurethane, a ditch or canal may be lined with the geotextile soaked with polyurethane-forming composition by (1) laying the soaked geotextile onto the surface of a canal or ditch, (2) conforming the soaked geotextile to the surface of the canal or ditch, and (3) allowing the polyurethane-forming composition to fully cure to form a water resistant liner.

### DETAILED DESCRIPTION OF THE INVENTION

The present invention relates to a polyurethane/geotextile composite useful as a liner for canals and ditches, to a process for the production of such composites and to a process for lining canals and ditches with such composite material and the lined canals and ditches made by this process. In the practice of the present invention, a geotextile is substantially soaked with a polyurethane-forming composition and the polyurethane-forming mixture is allowed to cure to form a polyurethane/geotextile composite material having particularly advantageous properties. A liner may be formed with such composite material by laying the soaked geotextile on a surface such as a canal or ditch before the polyurethane-forming composition has completely cured and the polyurethane-forming composition is allowed to cure to form the polyurethane/geotextile composite of the present invention. When used as a liner, the soaked geotextile is preferably laid on the surface of the article to be lined and conformed to that surface before the polyurethane-forming composition is allowed to fully cure.

The polyurethane-forming composition employed in the present invention includes:

a) a liquefied monomeric diphenylmethane diisocyanate having a functionality of about two, a viscosity which is sufficiently low that the diisocyanate will flow under the conditions of use, a freezing point lower than 20° C., and an isocyanate content of at least 10% by weight,

b) at least one polyether polyol containing from 2 to 6 hydroxyl groups and having a number average molecular weight of at least 250,

c) 0 to 10% by weight of a low molecular weight diol or triol having an equivalent weight of 31 to 99,

d) up to 0.5 parts by weight per hundred parts by weight of polyol b) of an organometallic catalyst,

e) from 0 to about 5.0 parts by weight per hundred parts by weight of polyol b) of a viscosity adjusting material; and

f) optional fillers, additives and auxiliary agents.

As used herein, the term “geotextile” refers to any woven or non-woven porous blanket or mat which is produced from natural or synthetic fibers. The terms “ditch” and “canal” are used interchangeably herein and refer to any liquid-carrying surface.

Geotextiles are known materials and have been used primarily to line earthen surfaces. Such liners may have secondary uses in lining roofs, ponds, reservoirs, landfills, and underground storage tanks, canals or ditches. Examples of geotextiles include woven and non-woven polypropylene, polyester, jute or cotton fabrics.

The isocyanate used in the polyurethane-forming compositions of the present invention is a liquefied, monomeric diphenylmethane diisocyanate having a functionality of about 2 (i.e., from 1.8 to 2.2); a viscosity sufficiently low that it will flow under the conditions of use, preferably from about 10 to 5,000 mPa.s at 25° C., more preferably from about 10 to about 3,000 mPa.s at 25° C., most preferably from about 10 to about 1,000 mPa.s at 25° C.; a freezing point lower than 20° C. and an isocyanate content of at least about 10% by weight, preferably from about 10 to about 33.6% by weight, more preferably from about 15 to about 32%, and most preferably from about 20 to about 30%.

Suitable liquefied diphenylmethane diisocyanates to be used in the isocyanate component of the present invention are known and commercially available. Methods for the production of such diisocyanates are known and any of those methods may be used to produce the diisocyanate employed in the present invention.

One method for obtaining a liquefied monomeric MDI is to use a mixture of the 4,4′ and 2,4′ isomers which at an isomer ratio of about 1:1, for example, have a freezing point between 15 and 20° C. The diphenylmethane diisocyanate will be liquid if it includes up to 70% (preferably from 1 to 55%) by weight of the 2,4′-isomer of diphenylmethane diisocyanate, no more than 2% (preferably no more than 1%) of the 2,2′-isomer of diphenylmethane diisocyanate, and the balance 4,4′-isomer of diphenylmethane diisocyanate, with the sum of the 2,2′-isomer, the 2,4′isomer and the 4,4′isomer totaling 100% by weight of the diphenylmethane diisocyanate. Liquid diphenylmethane diisocyanates that contain more than 90% of the 4,4′-isomer are particularly preferred isomeric mixtures.

Modified liquid diphenylmethane diisocyanates are the preferred isocyanates to be used in the present invention. These modified liquid isocyanates include allophanate-modified diphenylmethane diisocyanate, diphenylmethane diisocyanates having carbodiimide groups and/or uretonimine groups, and prepolymers which are the reaction product of diphenylmethane diisocyanate with a polyether polyol, preferably a polyether polyol containing at least 80% by weight of ether units derived from propylene oxide.

As used herein, “allophanate group” refers to the structure:

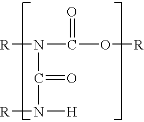

As used herein, “uretonimine group” refers to the structure:

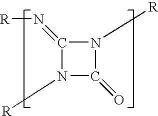

As used herein, “carbodiimide group” refers to the structure:

R[N═C═N]R

The liquefied isocyanates useful in the practice of the present invention may be prepared by chemical modification of monomeric diphenylmethane diisocyanate (MDI). Suitable modifications include: reaction with a polyether polyol, diol or monoalcohol to form urethane and/or allophanate containing liquid MDI-derivatives; and use of special catalysts to react isocyanate groups with themselves to form carbodiimide and/or uretonimine containing liquid MDI-derivatives.

Examples of suitable isocyanates are liquid MDI-derivatives containing carbodiimide groups of the type described in U.S. Pat. No. 3,152,162; liquid MDI-derivatives containing urethane groups of the type described, for example, in U.S. Pat. Nos. 3,394,164 and 3,644,457; liquid MDI-derivatives containing allophanate groups of the type described, for example, in British Patent 994,890, Belgian Patent 761,616, and published Dutch Patent Application 7,102,524.

It is also possible to use mixtures of the liquefied polyisocyanates described above.

The polyether polyols useful in the practice of the present invention contain from 2 to 6 hydroxyl groups, preferably from 2 to 4 hydroxyl groups, most preferably from 2 to 3 hydroxyl groups and have a number average molecular weight of at least 250, preferably from 250 to about 8,000, most preferably from about 400 to about 4,000. Such polyether polyols are known and commercially available. Any of the known techniques for the production of such polyether polyols may be used to produce the polyether polyols employed in the practice of the present invention.

Suitable polyether polyols useful in the polyurethane-forming composition employed in the practice of the present invention include: polyethers prepared, for example, by the polymerization of epoxides such as ethylene oxide, propylene oxide, butylene oxide, tetrahydrofuran, styrene oxide, or epichlorohydrin, optionally in the presence of Lewis acids such as BF₃; and those prepared by chemical addition of such epoxides, optionally added as mixtures or in sequence, to starting components containing reactive hydrogen atoms, such as water, alcohols, or amines. Examples of suitable starting components include: ethylene glycol; 1,3- and/or 1,2-propanediol; 1,2-, 1,3-, and/or 1,4-butanediol; trimethylolpropane; 4,4′-dihydroxydiphenylpropane; aniline; ammonia; ethanolamine; and ethylene diamine. Sucrose polyethers of the type described, for example, in German Offenlegungsschriften 1,176,358 and 1,064,938 may also be used in the present invention. Polyethers which contain predominantly primary hydroxyl groups (i.e., up to about 90% by weight, based on all of the hydroxyl groups in the polyether) are also suitable. Polyethers modified by vinyl polymers of the kind obtained, for example, by the polymerization of styrene and acrylonitrile in the presence of polyethers (disclosed, e.g., in U.S. Pat. Nos. 3,383,351, 3,304,273, 3,523,093, and 3,110,695 and German Patent 1,152,536) are also suitable, as are polybutadienes containing hydroxyl groups. Particularly preferred polyether polyols include: polyoxyalkylene polyether polyols, such as polyoxyethylene diol, polyoxypropylene diol, polyoxybutylene diol, and polytetramethylene diol, as well as polyoxypropylene polyoxyethylene triols.

Other suitable polyether polyols include the so-called “PHD polyols”, which are prepared by reaction of an organic polyisocyanate, hydrazine, and polyether polyol. U.S. Pat. No. 3,325,421, for example, discloses a method for producing suitable PHD polyols by reacting a stoichiometric or substoichiometric quantity (relative to diamine) of polyisocyanate dissolved in a polyol having a molecular weight of at least 500 and a hydroxyl number of no more than 225. U.S. Pat. Nos. 4,042,537 and 4,089,835 also disclose suitable PHD polyols.

Suitable polyether polyols also include the so-called “polymer polyols”, which are prepared by polymerizing styrene and acrylonitrile- in the presence of a polyether. See, for example, U.S. Pat. Nos. 3,383,351, 3,304,273, 3,523,093, 3,652,639, 3,823,201 and 4,390,645.

The most preferred polyethers are polyoxypropylene polyethers that do not contain ethylene glycol units.

Polyol mixtures may, of course, also be used in the practice of the present invention. Such polyol mixtures may include more than one polyether polyol having from 2 to 6 hydroxyl groups and a number average molecular weight of at least 250. Such polyol mixtures may also include other polyols and/or polyether polyols which do not satisfy the hydroxyl group and/or molecular weight criteria of the required polyether polyol.

A particularly preferred polyol mixture useful in the practice of the present invention includes the following components: (i) at least one propylene oxide adduct of an amine-containing starting component which adduct has a number average molecular weight of up to 1000 (preferably from 400 to 600); (ii) at least one propylene oxide adduct of a low molecular weight organic compound having from 3 to 6 OH groups which adduct has a number average molecular weight no greater than 1000 (preferably from 600 to 800); and (iii) at least one propylene oxide adduct of a low molecular weight diol which adduct has a molecular weight no greater than 3000 (preferably from 1500 to 2500). The mixture preferably contains from 5 to 15 parts by weight of the amine/propylene oxide adduct (i). The amounts of adducts (i), (ii) and (iii) used are such that the average OH functionality of the mixture is greater than 2.0 but less than 2.8.

Among the polyols which may be included in the polyol component containing the required polyether polyol are low molecular weight (i.e., equivalent weight of from 31 to 99) diols and triols which are different from the required polyether polyol. These low molecular weight diols and/or triols may be included in amounts of from 0 to 10% by weight, preferably from 0 to 5% by weight, based on total weight of polyol.

The polyurethane-forming mixture used in the practice of the present invention also includes a catalyst capable of catalyzing the reaction between isocyanate groups and hydroxyl groups (i.e., a urethane catalyst). Such catalysts are well known in the art and any of these known catalysts which does not also catalyze the reaction between an isocyanate group and water may be used in the present invention. Suitable catalysts include organometallic compounds. Preferred catalysts include organic tin compounds of the tin(II) salts of carboxylic acids such as tin(II) acetate, tin(II) octoate, tin(II) ethyl hexoate and tin(II) laurate and of tin(IV) compounds such as dibutyl tin oxide, dibutyl tin dichloride, dibutyl tin diacetate, dibutyl tin dilaurate, dibutyl tin maleate, dioctyl tin diacetate and the like. Mixtures of such catalysts may also be used.

The catalyst is used in an amount of up to 0.5 parts by weight per 100 parts by weight, based on the weight of the polyether polyol, preferably from 0.001 to 0.1 parts by weight.

The polyurethane-forming mixture used in the practice of the present invention may also include one or more viscosity adjusting materials. Examples of suitable viscosity adjusting materials include diamines, polyamines and amine-terminated polyols. Suitable viscosity adjusting amines include any of the known aliphatic, cycloaliphatic and aromatic diamines and/or triamines having a molecular weight of from about 62 to 400, preferably, aliphatic, cycloaliphatic, and aromatic diamines having only primary amino groups. Particularly preferred diamines are aliphatic and cycloaliphatic diamines such as bis(4-aminocyclohexyl)methane and 1-amino-3,3,5-trimethyl-5-aminomethylcyclohexane (“IPDA”). A most preferred diamine is bis(4-aminocyclohexyl)methane.

Aromatic diamines are also suitable for use as a viscosity adjusting material. Typically, such aromatic diamines have molecular weights of from about 108 to about 400 and preferably contain exclusively aromatically bound primary or secondary (preferably primary) amino groups. The aromatic diamines preferably have alkyl substituents in at least one position ortho to the amino groups. Particularly preferred aromatic diamines have at least one C₁-C₃ alkyl substituent located ortho to one of the amino groups and two C₁-C₃ alkyl substituents located ortho to the other amino group. The most preferred aromatic diamines have an ethyl, propyl, and/or isopropyl substituent in at least one ortho position relative to one amine group and methyl substituents present in the ortho positions relative to the other amine group. Mixtures of such aromatic diamines are, of course, also suitable. Specific examples of suitable aromatic diamines include: 2,4-diaminomesitylene; 1,3,5-triethyl-2,4-diaminobenzene; 1,3,5-triisopropyl-2,4-diaminobenzene; 1-methyl-3,5-diethyl-2,4-diaminomesitylene; 1-methyl-3,5-diethyl-2,6-diaminobenzene; 4,6-dimethyl-2-ethyl-1,3-diaminobenzene; 3,5,3′,5′-tetraethyl-4,4-diaminodiphenylmethane; 3,5,3′,5′-tetraisopropyl-4,4′-diaminodiphenylmethane; and 3,5-diethyl-3′,5′-diisopropyl-4,4′-diaminodiphenylmethane. Other suitable but less preferred aromatic diamines include: 1,4-diaminobenzene; 2,4-diaminotoluene; 2,4′- and/or 4,4′-diaminodiphenylmethane; 3,3′-dimethyl-4,4′-diaminodiphenylmethane; 4,4′-diaminodiphenyl propane-(2,2); t-butyl toluene diamine; 1-methyl-3,5-bis-(methylthio)-2,4- and/or -2,6-diaminobenzene; and mixtures of such diamines. Particularly preferred aromatic diamines include: diethyl toluene diamines such as 1-methyl-3,5-diethyl-2,4-diaminobenzene, either alone or as a mixture with 1-methyl-3,5-diethyl-2,6-diaminobenzene.

Suitable but much less preferred viscosity adjusting amines contain both hydroxyl and amino groups. Mixtures of such compounds with the compounds mentioned above are, of course, also suitable.

Also suitable for adjusting the viscosity of the polyurethane-forming mixture employed in the practice of the present invention are polyethers terminated with aromatic amino groups, the so-called “amine terminated polyethers” containing aromatically bound primary or secondary (preferably primary) amino groups. Compounds containing amino end groups can also be attached to the polyether chain through urethane, ester, or ether groups. These aromatic amine terminated polyethers can be prepared by any of several methods known in the art.

In one method for preparing aromatic amine terminated polyethers, relatively high molecular weight polyether polyols of the type suitable for use in the polyurethane-forming mixture employed in the practice of the present invention may be converted into the corresponding anthranilic acid esters by reaction with isatoic acid anhydride. Methods for making polyethers containing aromatic amino end groups are disclosed, for example, in German Offenlegungsschriften 2,019,432 and 2,619,840 and U.S. Pat. Nos. 3,808,250; 3,975,428: and 4,016,143. Relatively high molecular weight compounds containing amino end groups may also be obtained according to German Offenlegungsschrift 2,546,536 or U.S. Pat. No. 3,865,791 by reacting an isocyanate prepolymer based on a polyhydroxyl poiyether with a hydroxyl-containing enamine, aldimine, or ketimine and hydrolyzing the reaction product.

Preferred aromatic amine terminated polyethers include those aminopolyethers obtained by the hydrolysis of compounds containing isocyanate end groups. For example, in a process disclosed in German Offenlegungsschrift 2,948,419, polyethers containing hydroxyl groups (preferably two or three hydroxyl groups) react with polyisocyanates to form isocyanate prepolymers whose isocyanate groups are then hydrolyzed in a second step to form amino groups. Preferred amine terminated polyethers are prepared by hydrolyzing an aromatic isocyanate compound having an isocyanate group content of from 0.5 to 40% by weight. The most preferred of such polyethers are prepared by first reacting a polyether containing from two to four hydroxyl groups with an excess of an aromatic polyisocyanate to form an isocyanate terminated prepolymer and then converting the isocyanate groups to amino groups by hydrolysis.

Other processes for the production of useful amine terminated polyethers using isocyanate hydrolysis techniques are described in U.S. Pat. Nos. 4,386,218; 4,454,730: 4,472,568; 4.501,873; 4,515,923; 4,525,534; 4,540,720; 4,578,500; and 4,565,645; European Patent Application 97,299; and German Offenlegungsschrift 2,948,419. Similar products are also described in U.S. Pat. Nos. 4,506,039; 4,525,590; 4,532,266; 4,532,317; 4,723,632; 4,724,252; and 4,855,504.

Other suitable amine terminated polyethers include aminophenoxy-substituted polyethers described, for example, in published European Patent Applications 288,825 and 268,849.

Diamines, polyamines, and amine-terminated polyethers can be used alone or combination to adjust the viscosity of the polyurethane-forming mixture. They can be added separately to the polyurethane-forming mixture or combined with any of the components to be included in the polyurethane-forming mixture prior to combination with the other components of the polyurethane-forming mixture.

The viscosity adjusting material may be included in any amount sufficient to increase the viscosity of polyurethane-forming mixture in a desirable way to avoid run-off from the soaked geotextile (particularly when that geotextile has been applied to a vertical surface) but still allow the polyurethane-forming mixture to flow to the location at which it will be used to soak the geotextile. Suitable amounts of diamine, polyamine and amine terminated polyether include from 0 to 5 parts per 100 parts of polyether polyol, low molecular weight diol and/or triol and any other isocyanate-reactive material included in the polyurethane-forming mixture, preferably, from 0.5 to 3 parts.

Optionally, one or more fillers may be included in the polyurethane/geotextile composites of the present invention. The fillers useful herein are known. Examples of suitable fillers include calcium carbonate, barium sulfate, kieselguhr, whiting, mica, glass fibers, liquid crystal fibers, glass flakes, glass balls, aramide fibers, and carbon fibers. In addition, ground solid plastics (such as polyurethane scrap), rubber wastes (such as from tires), or any kind of ground rubber may be used.

If a filler is used, it can be added to any of the components to be used in the polyurethane-forming mixture before that component is added to the polyurethane-forming mixture or it may be separately metered into the polyurethane-forming mixture.

When used, the filler is generally included in the polyurethane-forming mixture in an amount of from 20 to 60% by weight.

Other known additives, auxiliary agents and processing aids such as surfactants, bacteriocides, fungicides, coloring agents, stabilizers and flame retardants may be included in the polyurethane-forming mixture employed in the practice of the present invention. However, because such materials may leach out of the polyurethane/geotextile composite during use and could detrimentally affect the water present in a ditch or canal lined with that composite, use of such additives and auxiliary agents is not preferred.

The liquefied monomeric MDI and isocyanate reactive materials used to produce the polyurethane-forming mixture employed in the practice of the present invention are combined in amounts such that the equivalent ratio of isocyanate groups to isocyanate-reactive groups (i.e., OH and/or NH groups) is from 1.4 to 0.9, preferably from 1.1 to 1.0.

It is preferred that the total water content of all isocyanate-reactive materials included in the polyurethane-forming reaction mixture include no more than 0.2% by weight, most preferably no more than 0.1% by weight of water before being reacted with the liquid polyisocyanate.

The polyurethane-forming composition employed in the practice of the present invention cures in a reasonable amount of time without application of any externally applied heat and under temperature conditions varying over a range of from 0° C. to 50° C.

The polyurethane-forming mixture employed in the present invention may be applied to one or more geotextiles by any of the techniques known to those skilled in the art and allowed to cure under suitable conditions to produce the polyurethane/geotextile composite of the present invention.

In one embodiment of the present invention, a ditch and/or canal is lined with the polyurethane/geotextile composite of the present invention using a machine of the type described in U.S. Pat. No. 5,639,331. In this embodiment, a mobile ditch lining apparatus having reservoirs for raw materials are connected to a mixing chamber through flexible conduit means. The delivery rate of the raw materials to the mixing chamber is varied depending upon the particular formulation and quantity thereof required for a specific incremental area of the liner being formed. The above-described components included in the polyurethane-forming mixture are combined in the mixing chamber. From the mixing chamber, the polyurethane composition is applied to one or more geotextiles. The geotextile is pulled from a vat containing the polyurethane-forming mixture through an adjustable die which provides even distribution of the polyurethane-forming mixture on the geotextile, determines how much polyurethane-forming mixture is dispensed on the geotextile, and also controls the thickness of the polyurethane-forming mixture which is soaked into the geotextile. The soaked geotextile is then cut to the desired length and placed in the canal or ditch where it is made to conform to the surface and cured to form a polyurethane/geotextile composite liner. Installing the polyurethane/geotextile liner in such a way that the sections of the soaked geotextile overlap to a certain extend assures that after curing a seamless permanent flexible polyurethane composite liner is obtained.

In another embodiment of the present invention, the polyurethane-forming mixture is spray applied to the geotextile using commercially available two-component polyurethane spray equipment. The polyurethane soaked geotextile is subsequently placed in the ditch or canal where it is made to conform to the surface and cures to form a polyurethane/geotextile composite. In another method for carrying out the process of the present invention, the geotextile is cut to size and placed in the canal or ditch to be lined and the polyurethane-forming mixture is subsequently sprayed onto the geotextile. Preferably, the geotextile soaked with the polyurethane-forming mixture is rolled with a paint roller to allow the polyurethane to penetrate through the geotextile to the surface of the ditch or canal before the polyurethane-forming mixture has completely reacted.

It is also possible to carry out the process of the present invention by first spraying the polyurethane-forming mixture onto one geotextile and then applying another geotextile over the first geotextile soaked with polyurethane-forming mixture.

In another embodiment of the invention, the polyurethane composition is sprayed on the (broken) concrete of a concrete lined ditch and a geotextile is subsequently placed over the sprayed concrete in a manner such that the geotextile absorbs the polyurethane-forming mixture to form a soaked geotextile which subsequently cures to form a solid yet flexible polyurethane/geotextile composite.

State of the art sprayable polyurethane formulations are not generally useful for lining canals or ditches in accordance with the present invention because they exhibit gel times of only several seconds. In order to prepare polyurethane/geotextile composites of the present invention, the polyurethane-forming mixture must have a gel time of at least three minutes, preferably more than 10 minutes.

If additional layers of polyurethane composite are desirable any of the above processes may be repeated one or more times.

The thickness of the polyurethane/geotextile composite can be varied over a wide range but usually measures from about 50 microns to about 500 microns.

The amount of polyurethane applied to the geotextile(s) can be varied but usually the polyurethane-forming mixture is applied in amounts of from 1 kg to 20 kg, preferably from 2 kg to 5 kg, per square meter.

If desirable several layers of the polyurethane soaked geotextile(s) may be applied over each other to obtain a composite of higher strength and dimensional stability. This is actually the preferred mode for lining an earthen canal or ditch.

The invention is further illustrated but is not intended to be limited by the following examples in which all parts and percentages are by weight unless otherwise specified.

### EXAMPLES

| | |
|---|---|
| Isocyanate A: | polymethylene poly (phenylisocyanate) having |
| (Comparison) | an NCO content of about 31.5%, a functionality |
| | of 2.8 and a viscosity at 25° C. of 200 mPa · s. |
| Isocyanate B: | diphenylmethane diisocyanate having an |
| | isomer distribution of about 98% by weight of |
| | the 4,4′-isomer, and less than 2% by weight of |
| | the 2,4′-isomer. This diisocyanate has an NCO |
| | content of about 33.6% and a functionality of |
| | 2.0. This isocyanate is a solid at |
| | 20° C. and has a melting point of 39° C. |
| Isocyanate C: | Mondur CD (available from Bayer Corp., a |
| | uretonimine modified liquid MDI having an |
| | NCO-content of about 29.5%, a functionality |
| | of about 2.2, and a viscosity at 25° C. of 50 |
| | mPa · s. This isocyanate is stable for at least 30 |
| | days at temperatures of 15° C. or greater. |
| Isocyanate D: | a diphenylmethane diisocyanate prepolymer |
| | having an NCO group content of about 23%, a |
| | functionality of about 2, a viscosity between |
| | 550 and about 800 mPa · s at 25° C. which is the |
| | reaction product of about 86.2% by weight of |
| | isocyanate B and about 13.8% by weight of |
| | tripropylene glycol. This prepolymer is stable |
| | for at least 30 days at temperatures of 18° C. or |
| | greater, but freezes below 15° C. |
| Isocyanate E: | 100 parts (pbw) of isocyanate B and 7.76 parts |
| | of 2-methyl-1-propanol heated to 60° C. were |
| | reacted in the presence of 0.01 parts of zinc |
| | acetylacetonate at 90° C. After one hour at |
| | 90° C. the NCO content was 23%. The reaction |
| | mixture was cooled to 60° C., 0.025 parts of |
| | benzoyl chloride were added and the reaction |
| | mixture was cooled to 25° C. This prepolymer |
| | had a functionality of about 2, a viscosity |
| | between 400 and 650 mPa · s and was stable |
| | for at least 30 days at temperatures of 5° C. or |
| | greater. |
| Isocyanate F: | 100 parts (pbw) of Isocyanate B and 5.45 |
| | parts of 2-methyl-1-propanol were heated to |
| | 60° C. and reacted in the presence of 0.01 |
| | parts of zinc acetylacetonate at 90° C. After |
| | one hour at 90° C. the NCO content was 26%. |
| | The reaction mixture was cooled to 60° C., |
| | 0.025 parts of benzoyl chloride were added. |
| | To 95.7 parts of this product were added 4.3 |
| | parts of tripropylene glycol at a rate such that |
| | the temperature was maintained at 60° C. ± |
| | 5° C., and the reaction mixture was held at |
| | 60° C. for about 2 hours. The resultant product, |
| | which had a functionality of about 2 and an |
| | isocyanate group content of about 22.8%, was |
| | a clear yellow liquid with a viscosity of 500 |
| | mPa · s. This prepolymer was stable for at |
| | least 30 days at temperatures of 10° C. or |
| | greater. |
| Isocyanate G: | a diphenylmethane diisocyanate prepolymer |
| | having a functionality of about 2.1, an NCO |
| | group content of about 21.6% and a viscosity |
| | of about 330 mPa · s at 25° C. which was the |
| | reaction product of about 75% by weight of |
| | Isocyanate C and 25% by weight of Polyol D. |
| | This prepolymer was stable for at least 30 |
| | days at temperatures of 5° C. or greater. |
| Isocyanate H: | a diphenylmethane diisocyanate composed of |
| | 44% by weight of the 4,4′-isomer, 54% by |
| | weight of the 2,4′-isomer and about 2% by |
| | weight of the 2,2′-isomer. This diisocyanate had |
| | an NCO content of about 33.6%, a functionality |
| | of about 2.0, a viscosity of less than about 25 |
| | mPa · s at 25° C. and was stable for at least 30 |
| | days at temperatures of 18° C. or greater. |
| Isocyanate I: | a diphenylmethane diisocyanate prepolymer |
| | having an NCO group content of about 23% and |
| | a viscosity of about 400-700 mPa · s at 25° C. |
| | which was the reaction product of about 86.8% |
| | by weight of Isocyanate H and about 13.2% by |
| | weight of tripropylene glycol. This isocyanate |
| | prepolymer had a functionality of about 2 and |
| | was stable for at least 30 days at temperatures |
| | of −20° C. or greater. |
| Isocyanate J: | A 1:1 blend of Isocyanate D and Isocyanate H |
| | having a functionality of about 2, a viscosity of |
| | about 600 mPa · s at 25° C., an NCO content of |
| | about 23.0% which was stable at temperatures |
| | of 10° C. or greater for at least 30 days. |
| Polyol A: | a monoethanolamine started propylene oxide |
| | polyether polyol, having an OH number of |
| | about 350, a functionality of about 3 and a |
| | number average molecular weight of about 480. |
| Polyol B: | a glycerine started propylene oxide polyether |
| | polyol, having an OH number of about 250, a |
| | functionality of about 3 and a number average |
| | molecular weight of about 670. |
| Polyol C: | a propylene glycol started propylene oxide |
| | having an OH number of 56, a functionality of |
| | about 2 and a number average molecular |
| | weight of about 2000. |
| Polyol D: | a glycerine started propylene oxide/ethylene |
| | oxide (ratio 87:13 by weight) having an OH |
| | number of 56, a functionality of about 3 and a |
| | number average molecular weight of about 6000. |
| Amine: | bis(4-aminocyclohexyl)methane |
| Catalyst: | dimethyltin dilaurate, commercially available as |
| | Fomrez UL-28 from Witco. |
| Geofabric: | Trevira Spunbound Type 1114, a 100% |
| | continuous filament polyester nonwoven |
| | needlepunched engineering fabric |
| | available from Fluid Systems, a division of |
| | Serrot International, Inc., Reno NV. |
| Polyol Blend A: | 10 pbw Polyol A |
| | 45 pbw Polyol B |
| | 45 pbw Polyol C |
| | 0.75 pbw Amine |
| | 0.01 pbw Catalyst |

### Examples 1-8

Polyurethane castings were prepared by handmixing the Polyisocyanate indicated in TABLE 1 in the amount indicated in TABLE 1 with 100 g of Polyol Blend A at an NCO:(OH+NH) equivalent ratio of 1.05:1.00 at 25-30° C. for about 2 minutes. The ratios by weight are given in Table 1. The mixture was then poured into a room temperature mold (6 in.×6 in.×0.125 in.), and the samples were allowed to cure at room temperature for 16 hours before demolding. The samples were stored for at least 1 week at room temperature in a temperature and humidity controlled environment and then tested for various physical and mechanical properties. The results are shown in Table 2.

TABLE 1

| | GRAMS OF | ISOCYANATE/GRAMS |
|---|---|---|
| EXAMPLE | POLYOL BLEND | OF ISOCYANATE |
| 1 | 100 | A/43.5 |
| 2 | 100 | G/64.3 |
| 3 | 100 | D/60.9 |
| 4 | 100 | E/60.4 |
| 5 | 100 | C/47.2 |
| 6 | 100 | F/59.8 |
| 7 | 100 | I/60.9 |
| 8 | 100 | J/60.9 |

TABLE 2

| Example | 1* | 2 | 3 | 4 | 5 | 6 | 7 | 8 |
|---|---|---|---|---|---|---|---|---|
| Tensile Strength (psi) | 959 | 996 | 1731 | 2206 | 1345 | 2258 | 1338 | 1139 |
| Elongation (%) | 68 | 116 | 196 | 143 | 136 | 144 | 193 | 174 |
| Split Tear (pli) | 15.4 | 31.1 | 69.8 | 145 | 54.2 | 70.3 | 94 | 68 |
| Die C Tear (pli) | 83 | 105 | 173 | 305 | 154 | 226 | 143 | 139 |
| Shore A 1 sec | 68 | 85 | 85 | 96 | 90 | 91 | — | — |
| Shore A 5 sec | 67 | 82 | 80 | 94 | 86 | 90 | 79 | 71 |
| Shore D 1 sec | 16 | 26 | 30 | 45 | 35 | 47 | — | — |
| Shore D 5 sec | 15 | 24 | 24 | 42 | 30 | 42 | 25 | 21 |

*Comparative Example

It can be seen from the data reported in TABLE 2 that the tear strength of the polyurethanes suitable for use in the practice of the present invention was dramatically increased by a factor of from 2 to about 10 (relative to the polymethylene poly(phenylisocyanate)-based polyurethane). Surprisingly, the hardness of the polyurethanes useful in the practice of the present invention was also increased in spite of the higher elongation values.

### Examples 9 and 10

Polyurethane/geofabric composites were prepared from polyurethane-forming mixtures corresponding to those prepared in Examples 4 and 1 (comparative), respectively, by the following procedure:

240 g of the liquid polyurethane-forming composition were poured onto one square foot of Geofabric which had been placed on a polyethylene film (for easy release) and evenly distributed over the Geofabric using a 3 inch wide rubber roller.

The soaked Geofabric was allowed to cure at room temperature for 16 hours before removal from the polyethylene sheet. Each of the samples was then stored for at least 1 week at room temperature in a temperature and humidity controlled environment and afterwards tested for various physical and mechanical properties. The results are shown in Table 3.

TABLE 3

| | 9 (Prepolymer | 10 (Prepolymer |
|---|---|---|
| Property/Example | of Example 4) | of Example 1)* |
| Tensile Strength (psi) | 1916 | 1505 |
| % Elongation | 71 | 50 |
| Split Tear (pli) | 55 | 57 |
| Die C Tear (pli) | 210 | 204 |

*Comparative

The test results reported in TABLE 3 clearly indicate that the physical properties such as tensile strength and elongation of a polyurethane/geotextile composite produced in accordance with the present invention were superior to those of a composite made with a polyurethane-forming mixture based on polymethylene poly(phenylisocyanate).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane/geotextile composite useful as a liner for canals and ditches comprising a geotextile substantially soaked with a polyurethane composition comprising:
a) a liquefied monomeric diphenylmethane diisocyanate having a functionality of about two, a viscosity sufficiently low that it will flow under use conditions, a freezing point lower than 20° C., and an isocyanate content of at least 10% by weight,
b) a polyether polyol containing from 2 to 6 hydroxyl groups and having a number average molecular weight of from about 250 to 8,000,
c) 0 to 10% by weight of a low molecular weight diol or triol having an equivalent weight of from 31 to 99 which is different from b),
d) up to 0.5 parts by weight per hundred parts by weight of components b)+c) of an organometallic catalyst,
e) 0 to about 5.0 parts by weight per hundred parts by weight of components b)+c) of a viscosity adjusting component, and
f) optionally, filler.

2. The composite of claim 1 in which components b) and c) contain a total of no more than 0.1% by weight of water prior to reaction with component a).

3. The composite of claim 1 in which the amount of each of components a), b), c) and e) is such that the NCO:[OH+NH] equivalent ratio is from 1.4 to 0.9.

4. The composite of claim 1 in which the amount of each of components a), b, c) and e) is such that the NCO:[OH+NH] equivalent ratio is from 1.1 to 1.0.

5. The composite of claim 1 in which the liquid polyisocyanate has an isocyanate group content greater than 20% by weight.

6. The composite of claim 1 in which the polyether polyol is a polyoxypropylene polyether having a molecular weight of from 400 to 4,000 and an average functionality of from 2 to 3.

7. The composite of claim 1 in which from 0.001 to 0.1% by weight of a tin compound is used as the catalyst.

8. The composite of claim 1 in which the liquid polyisocyanate contains urethane and/or allophanate and/or carbodiimide and/or uretonimine groups.

9. The composite of claim 1 in which the liquid diisocyanate contains less than 10% by weight of 2,4′-diphenylmethane diisocyanate.

10. The composite of claim 1 in which 0% component c) is included.

11. The composite of claim 1 in which the geotexile is soaked with sufficient polyurethane forming mixture that the amount of polyurethane present in the composite ranges from 1 kg to 20 kg of polyurethane per square meter of geotextile.

12. The composite of claim 1 in which the geotextile is soaked with sufficient polyurethane forming mixture that the amount of polyurethane present in the composite ranges from 2 kg to 5 kg per square meter of geotextile.

13. The composite of claim 1 having a thickness of from about 50 microns to about 500 microns.

14. A process for forming a polyurethane/geotextile composite liner for canals and ditches comprising
(1) substantially soaking a geotextile with a polyurethane forming composition comprising:
a) a liquefied monomeric diphenylmethane diisocyanate having a functionality of about two, a viscosity sufficiently low that it will flow under use conditions, a freezing point lower than 20° C., and an isocyanate content of at least 100% by weight,
b) a polyether polyol containing from about 2 to about 6 hydroxyl groups and having a number average molecular weight of from at least 250 to about 8,000,
c) 0 to 10% by weight of a diol or triol having an equivalent weight of from 31 to 99,
d) up to 0.5 parts by weight per hundred parts by weight of b)+c) of an organometallic catalyst,
e) from 0 to about 5.0 parts by weight per hundred parts by weight of b)+c) of a viscosity adjusting material; and
f) optionally, filler
(2) allowing the polyurethane forming composition to cure.

15. The process of claim 14 in which components b) and c) contain a total amount of water of no more than 0.1% by weight prior to reaction with the liquid polyisocyanate

16. The process of claim 14 in which components a), b), c) and e) are used in amounts such that the NCO:[OH+NH] equivalent ratio is from about 1.4 to 0.9.

17. The process of claim 14 in which components a), b), c) and e) are used in amounts such that the NCO:[OH+NH] equivalent ratio is from 1.1 to 1.0.

18. The process of claim 14 in which component a) has an isocyanate group content of greater than 20% by weight.

19. The process of claim 14 in which component b) is a polyether polyol having a molecular weight of from 400 to 4,000 and an average functionality of from 2 to 3.

20. The process of claim 14 in which from 0.001 to 0.1% by weight of a tin compound is used as component d).

21. The process of claim 14 in which component a) includes urethane and/or allophanate and/or carbodiimide and/or uretonimine groups.

22. The process of claim 14 in which component a) includes less than 10% by weight of 2,4′-diphenylmethane diisocyanate.

23. The process of claim 14 in which 0% diol or triol is used as component c).

24. The process of claim 14 in which the geotextile is soaked with the polyurethane forming composition in an amount such that from 1 to 20 kg of polyurethane per square meter of geotextile will be present.

25. The process of claim 14 in which the geotextile is soaked with the polyurethane forming composition in an the amount such that from 2 to 5 kg of polyurethane per square meter of geotextile will be present.

26. The process of claim 14 in which the polyurethane/geotextile composite is produced at a thickness of from 50 microns to about 500 microns.

27. A canal or ditch lined with the composite of claim 1.

28. A process for lining a canal or ditch with a polyurethane/geotextile composite comprising:
(1) dispensing a polyurethane forming composition comprising
a) a liquefied monomeric diphenylmethane diisocyanate having a functionality of about two, a viscosity sufficiently low that it will flow under use conditions, a freezing point lower than 20° C., and an isocyanate content of at least 10% by weight,
b) a polyether polyol containing from about 2 to about 6 hydroxyl groups and having a number average molecular weight of from about 250 to about 8,000,
c) 0-10% by weight of diol and/or triol having an equivalent weight of from about 31 to about 99,
d) up to 0.5 parts by weight per hundred parts by weight b)+c) of an organometallic catalyst,
e) 0-5.0 parts by weight, based on total weight of b)+c) of a viscosity adjusting material, and
f) optionally, filler
onto a geotextile,
(2) laying the geotextile soaked with polyurethane forming composition onto a surface of a canal or ditch before the polyurethane forming composition has fully cured,
(3) conforming the geotextile soaked with polyurethane forming mixture to the surface of the canal or ditch,
(4) allowing the polyurethane forming composition to fully cure and thereby form a water resistant liner.

29. A lined ditch or canal produced by the process of claim 28.
